(19) United States
(12) Patent Application Publication
(10) Pub. No.: US 2012/0098176 A1
(43) Pub. Date: Apr. 26, 2012

(54) FLUID-FILLED CYLINDRICAL VIBRATION-DAMPING DEVICE

(75) Inventor: Toru MATSUSHITA, Komaki-shi (JP)

(73) Assignee: TOKAI RUBBER INDUSTRIES, LTD., KOMAKI-SHI, AICHI (JP)

(21) Appl. No.: 13/206,159

(22) Filed: Aug. 9, 2011

(30) Foreign Application Priority Data
Oct. 26, 2010 (JP) 2010-239315

(51) Int. Cl. F16F 13/16

(52) U.S. Cl. 267/140.13

(57) ABSTRACT

A fluid-filled cylindrical vibration-damping device including: a main rubber elastic body elastically connecting an inner shaft member and an outer cylindrical member; a pair of first fluid chambers opposed to each other in a first diametric direction with the inner shaft member being interposed therebetween; and a pair of second fluid chambers opposed to each other in a second diametric direction orthogonal to the first diametric direction. Each partition wall that circumferentially partition the first fluid chambers and the second fluid chambers respectively extend between the inner shaft member and the outer cylindrical member in a direction in more proximity to the second diametric direction than to the first diametric direction. The main rubber elastic body is provided with a hollow portion so that at least a part of the wall of the second fluid chamber is defined by a thin-walled flexible film.

### INCORPORATED BY REFERENCE

The disclosure of Japanese Patent Application No. 2010-239315 filed on Oct. 26, 2010 including the specification, drawings and abstract is incorporated herein by reference in its entirety.

### BACKGROUND OF THE INVENTION

1. Field of the Invention

The present invention relates generally to a cylindrical vibration-damping device adapted for use as an automotive suspension bushing, for example, and more particularly to a cylindrical vibration-damping device of fluid-filled type, which is capable of exhibiting vibration damping effects based on the flow action of a fluid filling the interior.

2. Description of the Related Art

Cylindrical vibration-damping devices for installation between components that make up a vibration transmission system in order to provide vibration-damped linkage or vibration-damped support of the components to one another are known in the art. These cylindrical vibration-damping devices have a construction in which an inner shaft member adapted to be mounted to one component of the vibration transmission system and an outer cylindrical member externally fitted about the inner shaft member so as to be spaced apart peripherally outward therefrom are connected with each other by a main rubber elastic body. In an effort to improve vibration damping capabilities of cylindrical vibration-damping devices, there have also been proposed cylindrical vibration-damping devices of fluid-filled type whose interior is filled with a non-compressible fluid. These cylindrical vibration-damping devices of fluid-filled type include a pair of first fluid chambers opposed to each other in a first diametric direction and a pair of second fluid chambers opposed to each other in a second diametric direction orthogonal to the first diametric direction, and an orifice passage connecting the first fluid chambers and the second fluid chambers with one another. On the basis of relative pressure differential arising between the fluid chambers induced by vibration input in the axis-perpendicular direction, fluid flow will be produced through the orifice passage and vibration damping effect will be attained on the basis of flow action etc. of the fluid. Such a device is disclosed in U.S. Pat. No. 7,866,639, for example.

Typically, a fluid-filled cylindrical vibration-damping device is disposed so that the opposing direction of the pair of the fluid chambers coincides with the principal vibration input direction. For example, the fluid-filled cylindrical vibration-damping device disclosed in U.S. Pat. No. 7,866,639 is mounted onto a vehicle so that the opposing direction of the pair of fluid chambers (48a, 48b) coincides with the principal vibration input direction. With this arrangement, during input of vibration, effective pressure fluctuations will arise in the pair of the fluid chambers (48a, 48b), whereby fluid flow will be produced through the orifice passage.

However, with the construction disclosed in U.S. Pat. No. 7,866,639, the wall of the fluid chambers is defined by a main rubber elastic body having excellent load bearing capability. This will limit the level of allowable change in volume of the pair of the fluid chambers (46a, 46b) which are opposed to each other in the second diametric direction orthogonal to the principal vibration input direction. As a result, during input of vibration in the principal vibration input direction, inflow and outflow of the fluid with respect to the pair of the fluid chambers (46a, 46b) may be limited in comparison with the amount of fluid flow through the orifice passage interconnecting the pair of the fluid chambers (48a, 48b). Consequently, in some instances, desired vibration damping effect may not sufficiently be obtained.

### SUMMARY OF THE INVENTION

The present invention has been developed in view of the above-described matters as the background, and it is an object of the present invention to provide a fluid-filled cylindrical vibration-damping device with an improved structure which is able to exhibit more excellent vibration damping effect against vibration input in the axis-perpendicular direction.

Specifically, a first mode of the present invention provides a fluid-filled cylindrical vibration-damping device including: an inner shaft member; an outer cylindrical member externally fitted about the inner shaft member; a main rubber elastic body elastically connecting the inner shaft member and the outer cylindrical member; a plurality of pocket portions provided in the main rubber elastic body so as to open onto an outer peripheral face of the main rubber elastic body; a plurality of fluid chambers defined by covering an opening of the pocket portions with the outer cylindrical member each filled with a non-compressible fluid, the plurality of fluid chambers comprising a pair of first fluid chambers opposed to each other in a first diametric direction with the inner shaft member being interposed therebetween and a pair of second fluid chambers opposed to each other in a second diametric direction orthogonal to the first diametric direction; an orifice passage connecting the first fluid chambers and the second fluid chambers; and partition walls that circumferentially partition the first fluid chambers and the second fluid chambers respectively, each of the partition walls extending between the inner shaft member and the outer cylindrical member in a direction in more proximity to the second diametric direction in which the pair of the second fluid chambers are opposed to each other than to the first diametric direction in which the pair of the first fluid chambers are opposed to each other, wherein the main rubber elastic body is provided with a hollow portion at a section which constitutes a wall of the second fluid chamber so that at least a part of the wall of the second fluid chamber is defined by a thin-walled flexible film.

With the fluid-filled cylindrical vibration-damping device according to the first mode, the hollow portion is provided in the wall of the second fluid chamber so that a part of the wall of the second fluid chamber is defined by the thin-walled flexible film, whereby the second fluid chamber more readily permits changes in volume. Therefore, during input of vibration in the first diametric direction, a large differential in fluid pressure will arise between the first fluid chambers and the second fluid chambers, efficiently producing fluid flow through the orifice passage. As a result, vibration damping effect on the basis of flow behavior of the fluid will be reinforced, thereby advantageously attaining desired high attenuating action or low dynamic spring effect.

Moreover, the main rubber elastic body extends in the direction in more proximity to the second diametric direction. Thus, in the first diametric direction, shear spring predominates and the spring constant is set low. Accordingly, the main rubber elastic body undergoes a large deformation with respect to the input load, inducing appreciable internal pressure fluctuations within the pair of the first fluid chambers. As a result, relative pressure differential between the first fluid chambers and the second fluid chambers becomes greater, so that ample fluid flow through the orifice passage will be ensured. By so doing, it is possible to effectively obtain desired vibration damping effect.

A second mode of the present invention provides the fluid-filled cylindrical vibration-damping device according to the first mode wherein the hollow portion extends in a circumferential direction between the inner shaft member and the outer cylindrical member so that the flexible film is provided in the wall situated on an inner peripheral side of the second fluid chamber.

According to the second mode, in the wall of the second fluid chamber, it is possible to ensure a large surface area for the section which is defined by the flexible film. With this arrangement, the second fluid chamber can enjoy a high level of allowable change in volume. Furthermore, the large surface area of the flexible film can be ensured efficiently with no need of making the main rubber elastic body larger in diameter. Thus, improved vibration damping ability will be achieved with a compact fluid-filled cylindrical vibration-damping device.

A third mode of the present invention provides the fluid-filled cylindrical vibration-damping device according to the first or second mode wherein the hollow portion includes a recess that opens onto an axial end face of the main rubber elastic body.

According to the third mode, the axial end wall of the second fluid chamber is defined by a thin-walled flexible film, whereby the second fluid chamber will readily permit changes in volume. This arrangement will ensure a large pressure differential between the first fluid chambers and the second fluid chambers. As a result, vibration damping effect on the basis of the flow behavior of the fluid will effectively be exhibited, making it possible to realize an excellent vibration damping ability. Moreover, by providing the recess that opens onto the axial end face of the main rubber elastic body, sufficient surface area of the thin-walled portion is ensured. Thus, more improved vibration damping ability will be achieved without increasing the size of the main rubber elastic body.

Note that it is also acceptable that both of the inner peripheral wall of the second fluid chamber and the axial end wall of the second fluid chamber are defined by the flexible film. With this arrangement, in the wall of the second fluid chamber, an even larger surface area can be ensured for the section which is defined by the flexible film. Consequently, the second fluid chamber more appreciably permits changes in volume, so that fluid flow through the orifice passage will be produced even more efficiently, thereby affording enhanced vibration damping effect on the basis of flow behavior of the fluid.

A fourth mode of the present invention provides the fluid-filled cylindrical vibration-damping device according to any one of the first through third modes, further including a stopper portion that projects into the pair of the first fluid chambers in the first diametric direction between the inner shaft member and the outer cylindrical member for limiting an amount of relative displacement of the inner shaft member and the outer cylindrical member in the first diametric direction by means of abutment of the inner shaft member and the outer cylindrical member via the stopper portion.

According to the fourth mode, the stopper portion is able to limit the amount of relative displacement of the inner shaft member and the outer cylindrical member. Therefore, during input of a large load, excessive deformation of the main rubber elastic body will be prevented, making it possible to improve durability. In particular, through a combination of the main rubber elastic body which gives rise primarily to shear deformation in the first diametric direction and the stopper portion which limits the deformation of the main rubber elastic body, the following advantages will be offered. That is, during input of normal vibration, fluid pressure fluctuation will efficiently be produced within the first fluid chambers; and during input of large jarring load, the deformation of the main rubber elastic body will be limited, thereby ensuring durability.

A fifth mode of the present invention provides the fluid-filled cylindrical vibration-damping device according to the fourth mode wherein the stopper portion projects in the first diametric direction from the inner shaft member towards the outer cylindrical member, and the main rubber elastic body is provided between a surface defined by the inner shaft member and the stopper portion and a surface of the outer cylindrical member opposed in the second diametric direction.

According to the fifth mode, the main rubber elastic body, which is provided between the surface defined by the inner shaft member and the stopper portion and the surface of the outer cylindrical member opposed in the second diametric direction, undergoes generally pure shear deformation during input of vibration in the first diametric direction. Meanwhile, during input of vibration in the second diametric direction, the main rubber elastic body primarily undergoes generally pure compressive deformation. Therefore, the spring constant in the first diametric direction can be set smaller than that in the second diametric direction. As a result, it is possible for automobiles, for example, to advantageously realize both excellent ride comfort and enhanced driving stability.

Besides, during input of vibration in the first diametric direction, the main rubber elastic body undergoes a larger deformation owing to its generally pure shear deformation, producing pressure fluctuations within the first fluid chambers more efficiently. This makes it possible to ensure a large amount of fluid flow through the orifice passage, thereby more advantageously exhibiting vibration damping effect on the basis of flow behavior of the fluid.

Furthermore, since the main rubber elastic body undergoes generally pure compressive deformation in the second diametric direction, sufficiently high spring rigidity can be achieved. Accordingly, it is possible to minimize reduction of the spring rigidity of the wall of the second fluid chambers associated with forming the hollow portion.

A sixth mode of the present invention provides the fluid-filled cylindrical vibration-damping device according to any one of the first through fifth modes wherein the pair of the first fluid chambers are formed so as to be opposed to each other in the first diametric direction which coincides with a principal vibration input direction.

According to the sixth mode, during input of principal vibration, internal pressure fluctuations will effectively be produced within the first fluid chambers, inducing fluid flow through the orifice passage. Consequently, vibration damping effect will be exhibited on the basis of flow behavior of the fluid with respect to vibrations which can be a problem in the first diametric direction.

The fluid-filled cylindrical vibration-damping device of construction according to the present invention employs the novel specific structure in which at least a part of the wall of the second fluid chamber is defined by a flexible film. Therefore, the second fluid chambers readily permit changes in volume, whereby ample fluid flow will be ensured through the orifice passage. Accordingly, vibration damping effect will advantageously be attained on the basis of flow behavior of the fluid. In addition, the main rubber elastic body has a specific shape which extends in the direction in more proximity to the second diametric direction. With this arrangement, shear deformation of the main rubber elastic body will efficiently induce internal pressure fluctuations within the first fluid chambers, thereby realizing more improved vibration damping effect.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a front view of a fluid-filled cylindrical vibration-damping device in the form of a suspension bushing according to a first embodiment of the present invention;

FIG. 2 is a longitudinal cross sectional view of the suspension bushing of FIG. 1, taken along line 2-2 of FIG. 3;

FIG. 3 is a cross sectional view taken along line 3-3 of FIG. 1;

FIG. 4 is a cross sectional view taken along line 4-4 of FIG. 1;

FIG. 5 is a top plane view of a first orifice member of the suspension bushing of FIG. 1;

FIG. 6 is a bottom plane view of a second orifice member of the suspension bushing of FIG. 1;

FIG. 7 is a perspective view for explaining assembly of the suspension bushing of FIG. 1; and

FIG. 8 is a graph demonstrating a comparison of vibration damping characteristics of the suspension bushing of FIG. 1 and those of a suspension bushing of conventional construction.

### DETAILED DESCRIPTION OF PREFERRED EMBODIMENTS

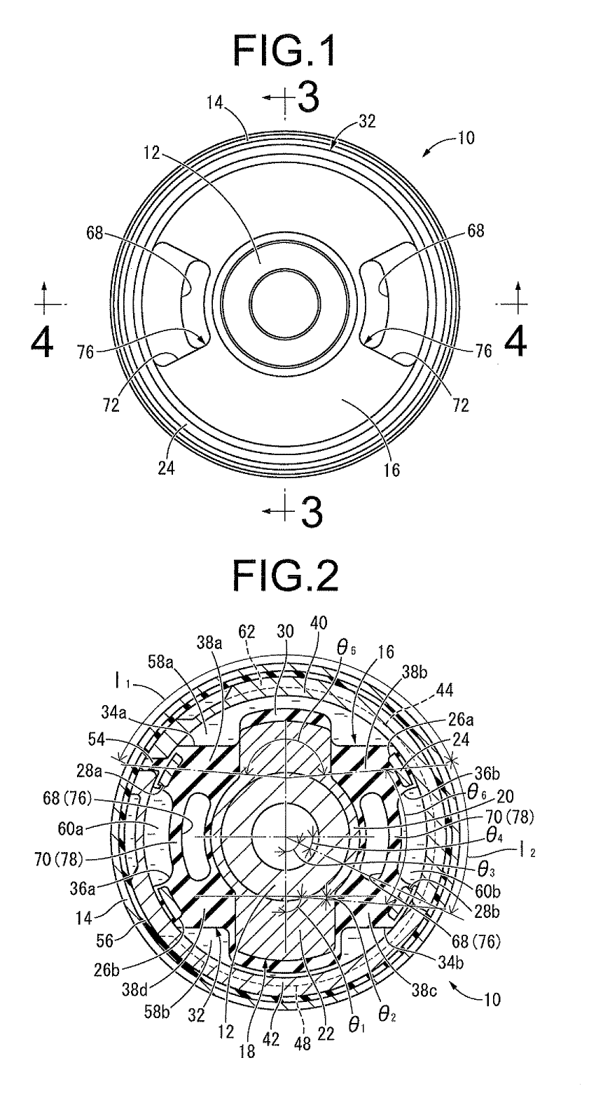

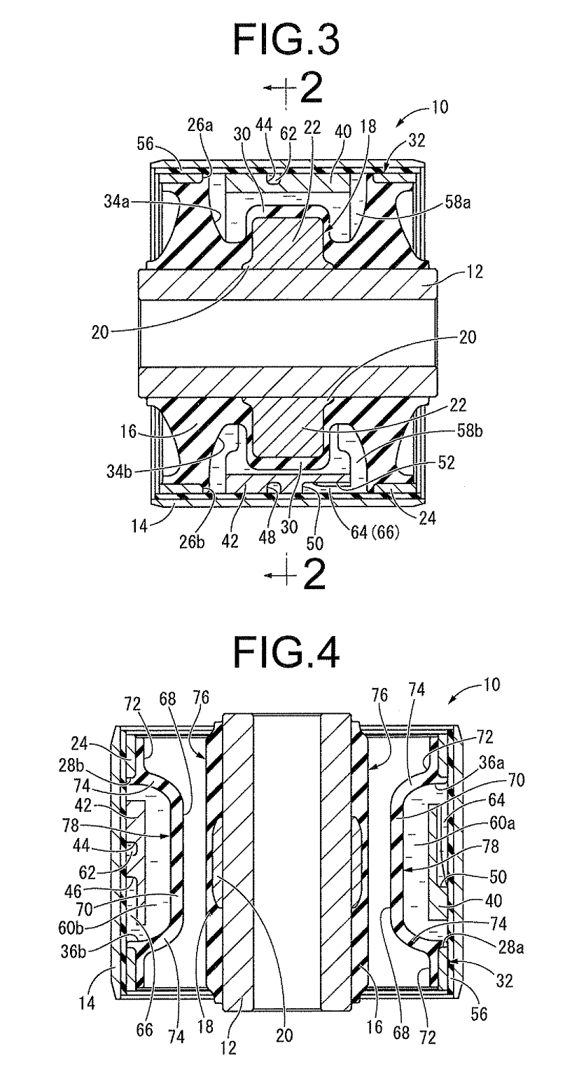

Referring to FIGS. 1 through 4, there is depicted an automotive suspension bushing 10 according to a first embodiment of a fluid-filled cylindrical vibration-damping device constructed in accordance with the present invention. The suspension bushing 10 has a construction in which an inner shaft member 12 and an outer cylindrical member 14 are connected by a main rubber elastic body 16. In the description hereinbelow, unless otherwise noted, the vertical direction refers to the vertical direction in FIG. 1, which coincides with the principal vibration input direction as well as the opposing direction of a pair of first fluid chambers 58a, 58b (hereinafter referred to as “first diametric direction”) to be described later. Also, the lateral direction refers to the lateral direction in FIG. 1, which coincides with the opposing direction of a pair of second fluid chambers 60a, 60b (hereinafter referred to as “second diametric direction”) to be described later.

Described more specifically, the inner shaft member 12 has a generally round tubular shape with a thick wall and small diameter, and is a highly rigid member formed of metal material such as iron or aluminum alloy. A stopper member 18 is mounted around the generally axial center section of the inner shaft member 12. The stopper member 18 has an integrally formed construction that includes an annular mounting portion 20 that is fitted externally onto the inner shaft member 12 and a stopper portion 22 that projects out to opposite sides in the first diametric direction of the mounting portion 20. The stopper member 18 is mounted onto the inner shaft member 12, whereby the stopper portion 22 projects diametrically outward from the inner shaft member 12.

To the diametrically outside of the inner shaft member 12 is disposed an intermediate sleeve 24. The intermediate sleeve 24 has a thin-walled, large-diameter, generally round tubular shape and is a highly rigid member formed of material similar to the inner shaft member 12. The axially medial portion of the intermediate sleeve 24 is made smaller in diameter than its opposite end portions about the entire circumference so as to have recessed groove contours.

In the axially medial portion of the intermediate sleeve 24, a first window portion 26a and a first window portion 26b are formed so as to be opposed to each other in the first diametric direction, while a second window portion 28a and a second window portion 28b are formed so as to be opposed to each other in the second diametric direction substantially orthogonal to the first diametric direction. Each of the first and second window portions 26a, 26b, 28a, and 28b pierces the intermediate sleeve 24 in the diametrical direction and these four window portions 26a, 26b, 28a, and 28b have the axial dimension generally equal to one another. Meanwhile, the second window portions 28a, 28b have a smaller dimension in the circumferential direction than do the first window portions 26a, 26b.

The intermediate sleeve 24 is externally fitted about the inner shaft member 12 and disposed so as to be diametrically spaced apart from the inner shaft member 12 with a prescribed distance. The main rubber elastic body 16 is disposed diametrically between the inner shaft member 12 and the intermediate sleeve 24. The main rubber elastic body 16 has a thick-walled, generally round tubular shape and is arranged with its inside peripheral face bonded by vulcanization to the outside peripheral face of the inner shaft member 12 while with its outside peripheral face bonded by vulcanization to the inside peripheral face of the intermediate sleeve 24. The stopper portion 22 of the stopper member 18 fixed to the inner shaft member 12 is covered by a rubber sheath layer 30 integrally formed with the main rubber elastic body 16. In particular, the rubber sheath layer 30 is made thicker at sections which are affixed to the projecting distal end faces of the stopper portion 22 in comparison with other sections. The main rubber elastic body 16 takes the form of an integrally vulcanization molded component 32 incorporating the inner shaft member 12, the stopper member 18, and the intermediate sleeve 24.

The main rubber elastic body 16 includes a pair of first pocket portions 34a, 34b opposed to each other in the first diametric direction. The first pocket portions 34a, 34b are of recessed shape that opens onto the outside peripheral face in the axially medial section of the main rubber elastic body 16, and have a circumferential length substantially equal to that of the first window portions 26a, 26b of the intermediate sleeve 24. The opening of the first pocket portion 34a of the main rubber elastic body 16 is exposed through the first window portion 26a of the intermediate sleeve 24 while the opening of the first pocket portion 34b is exposed through the first window portion 26b.

The main rubber elastic body 16 further includes a second pocket portions 36a, 36b opposed to each other in the second diametric direction. The second pocket portions 36a, 36b are of recessed shape that opens onto the outside peripheral face in the axially medial section of the main rubber elastic body 16, and have a circumferential length substantially equal to that of the second window portions 28a, 28b of the intermediate sleeve 24. The opening of the second pocket portion 36a of the main rubber elastic body 16 is exposed through the second window portion 28a of the intermediate sleeve 24 while the opening of the second pocket portion 36b is exposed through the second window portion 28b. It should be appreciated that the opposing direction of the pair of the first pocket portions 34a, 34b (the first diametric direction) and the opposing direction of the pair of the second pocket portions 36a, 36b (the second diametric direction) are substantially orthogonal to each other.

In the main rubber elastic body 16, the sections which circumferentially partition the first pocket portions 34a, 34b and the second pocket portions 36a, 36b constitute partition walls 38a through 38d. As depicted in FIG. 2, there are formed four partition walls 38a, 38b, 38c and 38d along the circumference of the main rubber elastic body 16. Each of these partition walls 38a through 38d extends substantially in the second diametric direction in which the pair of the second pocket portions 36a, 36b are opposed to each other, with one end bonded by vulcanization to the stopper portion 22 while the other end bonded by vulcanization to the intermediate sleeve 24. That is, in the second diametric direction, the partition walls 38a through 38d that make up part of the main rubber elastic body 16 are provided between opposed faces of the stopper portion 22 and the intermediate sleeve 24.

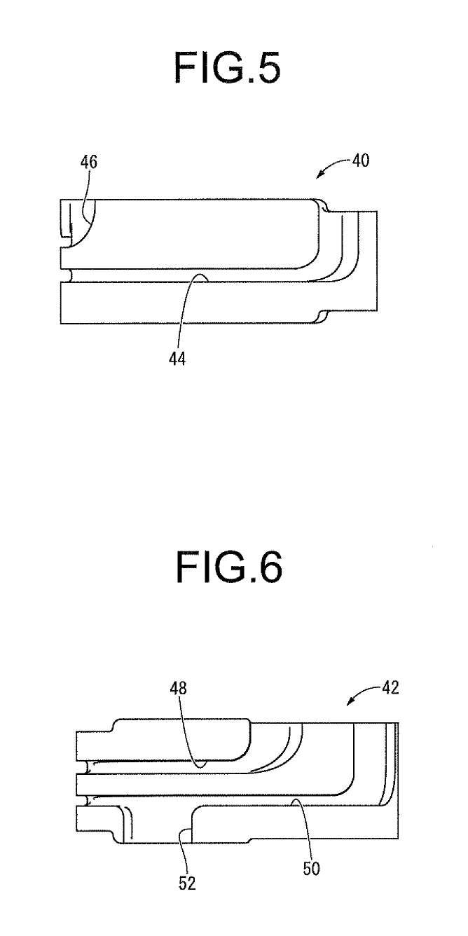

A first orifice member 40 and a second orifice member 42 are attached to the integrally vulcanization molded component 32 of the main rubber elastic body 16. As depicted in FIGS. 2 through 5, the first orifice member 40 has generally arcuate plate shape and extends a length about equal to halfway around the circumference. In the first orifice member 40, there are formed a first slot 44 and a second slot 46 extending a prescribed length in the circumferential direction, each arranged so that one end opens onto the circumferential end face of the first orifice member 40 (the circumferential end face positioned leftward in FIG. 5) while the other end opens onto the axial end face of the first orifice member 40 (the upper end face in FIG. 5) in proximity to the respective circumferential ends thereof.

The second orifice member 42, as depicted in FIGS. 2 through 4 and FIG. 6, has a shape similar to the first orifice member 40, namely, generally arcuate plate shape extending a length about equal to halfway around the circumference. In the second orifice member 42, there are formed a third slot 48 and a fourth slot 50 extending a prescribed length in the circumferential direction. The third slot 48 is arranged so that one end opens onto the axial end face of the circumferentially medial section of the second orifice member 42 (the upper end face in FIG. 6) while the other end opens onto the circumferential end face of the second orifice member 42 (the circumferential end face positioned leftward in FIG. 6). Meanwhile, the fourth slot 50 is arranged so that one end opens onto the axial end face of the second orifice member 42 (the upper end face in FIG. 6) in proximity to the circumferential end thereof while the other end opens onto the circumferential end face of the second orifice member 42 (the circumferential end face positioned leftward in FIG. 6). In addition, the circumferentially medial section of the fourth slot 50 opens onto the axial end face of the second orifice member 42 (the lower end face in FIG. 6) via an intermediate communicating slot 52.

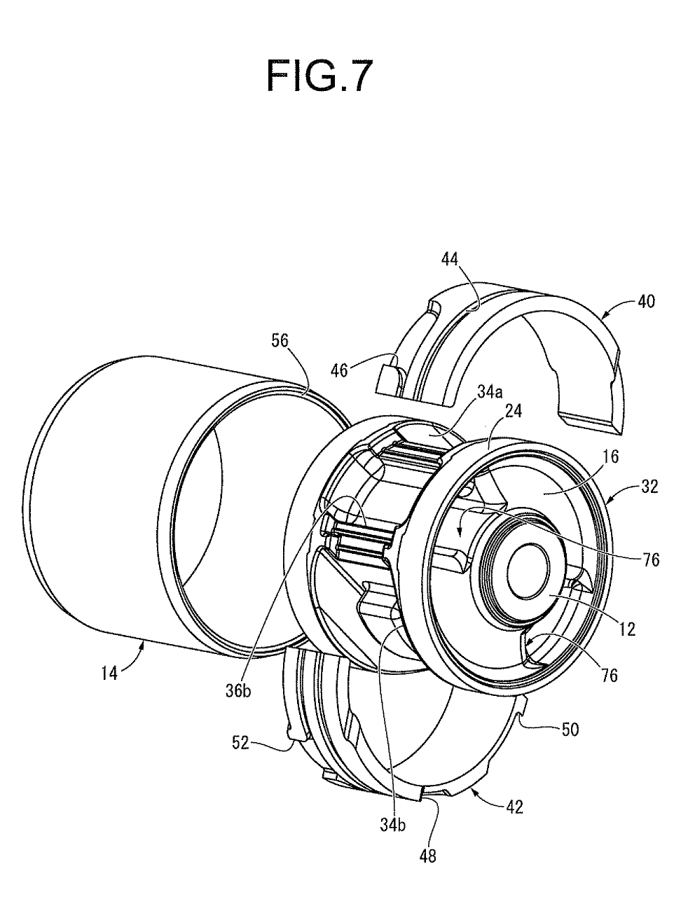

As depicted in FIG. 7, the first and second orifice members 40, 42 are attached to the axially medial section of the intermediate sleeve 24 from diametrically opposite sides. With this arrangement, the first slot 44 of the first orifice member 40 and the third slot 48 of the second orifice member 42 communicate with each other while the second slot 46 of the first orifice member 40 and the fourth slot 50 of the second orifice member 42 communicate with each other. A cushioning rubber 54 that is integrally formed with the main rubber elastic body 16 and projects out from the outside peripheral face of the intermediate sleeve 24 is clasped between one circumferential ends of the first and second orifice members 40, 42. By so doing, dimensional errors of the first and second orifice members 40, 42 in the circumferential direction are allowable owing to elasticity of the cushioning rubber 54.

Moreover, as depicted in FIG. 2, the outer cylindrical member 14 is mounted onto the integrally vulcanization molded component 32 to which the first and second orifice members 40, 42 have been attached. The outer cylindrical member 14 has a thin-walled, large-diameter, generally round tubular shape and its inside peripheral face is covered over substantially the entire surface by a thin seal rubber layer 56. As depicted in FIG. 7, the outer cylindrical member 14 is externally fitted about the integrally vulcanization molded component 32 as well as the first and second orifice members 40, 42, and then is subjected to a diameter reduction process such as 360-degree radial compression in order to be secured to the integrally vulcanization molded component 32 as well as the first and second orifice member 40, 42. With the outer cylindrical member 14 secured fitting with the intermediate sleeve 24 which is secured to the outside peripheral face of the main rubber elastic body 16, the inner shaft member 12 and the outer cylindrical member 14 are elastically connected to each other.

By means of the outer cylindrical member 14 being fluid-tightly secured to the intermediate sleeve 24 via the seal rubber layer 56, the first and second window portions 26, 28 are covered with the outer cylindrical member 14. With this arrangement, the opening of the first pocket portions 34a, 34b is fluid-tightly covered with the outer cylindrical member 14, thereby providing the pair of the first fluid chambers 58a, 58b opposed to each other in the first diametric direction. Furthermore, the opening of the second pocket portions 36a, 36b is fluid-tightly covered with the outer cylindrical member 14, thereby providing the pair of the second fluid chambers 60a, 60b opposed to each other in the second diametric direction substantially orthogonal to the first diametric direction.

It should be noted that the pair of the first fluid chambers 58a, 58b have greater dimension in the circumferential direction than do the pair of the second fluid chambers 60a, 60b. With this arrangement, in the main rubber elastic body 16, each of the partition walls 38a through 38d extends between the inner shaft member 12 and the intermediate sleeve 24 in the direction in more proximity to the second diametric direction than to the first diametric direction.

Specifically, as viewed in the transverse cross section, the angle: θ₁ formed by the first diametric direction and the elastic principal axis of the partition wall 38c that extends in the opposing direction of the inner shaft member 12 and the intermediate sleeve 24 for example is larger than the angle: θ₂ formed by the second diametric direction and the elastic principal axis of the partition wall 38c (θ₁>θ₂).

That is, viewed in the transverse cross section, when imaging hypothetically a partition-wall diametrical line that connects the diametrical center point of the inner shaft member 12 and the point of intersection between the elastic principal axis of the partition wall 38c and the outer cylindrical member 14, the angle: θ₃ formed by the partition-wall diametrical line and the first diametric direction is greater than the angle: θ₄ formed by the partition-wall diametrical line and the second diametric direction (θ₃>θ₄).

In other words, viewed in the transverse cross section, the circumferential distance: l₁ between the points of intersections of the outer cylindrical member 14 and the elastic principal axes of the pair of the partition walls 38a, 38b (38c, 38d) that constitute the walls of the first fluid chamber 58a (58b) is greater than the circumferential distance: l₂ between the points of intersections of the outer cylindrical member 14 and the elastic principal axes of the pair of the partition walls 38b, 38c (38a, 38d) that constitute the walls of the second fluid chamber 60b (60a) (l₁>₂).

In yet other words, in the present embodiment, the angle: θ₅ formed by the elastic principal axes of the pair of the partition walls 38a, 38b (38c, 38d) that constitute the walls of the first fluid chamber 58a (58b) is set greater than the angle: θ₆ formed by the elastic principal axes of the pair of the partition walls 38b, 38c (38a, 38d) that constitute the walls of the second fluid chamber 60b (60a) (θ₅>θ₆).

A non-compressible fluid is sealed within each of the first and second fluid chambers 58a, 58b, 60a, and 60b. While the non-compressible is not limited in particular, water, an alkylene glycol, a polyalkylene glycol, silicone oil, or a mixture of these, for example, would preferably be employed. In particular, in order to advantageously achieve vibration damping effect based on flow behavior of the fluid, it is desirable to use a low-viscosity fluid having viscosity of 0.1 Pa·s or lower. In the present embodiment, water is employed as the non-compressible fluid. Sealing of the non-compressible fluid within the fluid chambers 58a, 58b, 60a, and 60b can be accomplished, for example, by carrying out assembly of the outer cylindrical member 14 while the components are submerged in the non-compressible fluid.

A stopper portion 22 projects into each of the pair of the first fluid chambers 58a, 58b in the first diametric direction. The stopper portion 22 is positioned with respect to the orifice member 40(42) so as to be spaced apart diametrically inward therefrom by a prescribed distance, or in a state of contact therewith. When large-amplitude vibration is input in the first diametric direction, the stopper portion 22 comes into abutment against the outer cylindrical member 14 via the orifice member 40(42). By so doing, the stopper portion 22 provides a stopper mechanism for limiting or inhibiting relative displacement of the inner shaft member 12 and the outer cylindrical member 14 in the first diametric direction. It should be noted that the rubber sheath layer 30 is affixed to the projecting distal end face of the stopper portion 22, so that the stopper portion 22 and the outer cylindrical member 14 will come into abutment against each other via the rubber sheath layer 30. This arrangement moderates the impact during abutment of the stopper portion 22 and the outer cylindrical member 14, thereby preventing occurrence of striking noise.

The outer cylindrical member 14 is juxtaposed against the outside peripheral faces of the first and second orifice members 40, 42 fluid-tightly via the seal rubber layer 56, thereby covering the openings of the first through fourth slots 44, 46, 48, and 50. With this arrangement, there is formed utilizing the first slot 44 and the third slot 48 a first orifice passage 62 that interconnects the first fluid chamber 58a and the first fluid chamber 58b. In addition, there is formed utilizing the second slot 46 and the fourth slot 50 a second orifice passage 64 that interconnects the first fluid chamber 58b and the second fluid chamber 60a as well as a third orifice passage 66 that interconnects the first fluid chamber 58b and the second fluid chamber 60b. In the present embodiment, the first orifice passage 62 is tuned to low frequency on the order of ten-plus Hz while the second and third orifice passages 64, 66 are tuned to mutually equal high frequency on the order of 50 Hz. It may alternatively be accepted that the second orifice passage 64 and the third orifice passage 66 have tuning frequencies different from each other. By so doing, an effective vibration damping action will be exhibited with respect to three different vibration inputs.

The main rubber elastic body 16 is provided with a through hole 68 at a section which constitutes the wall of the second fluid chamber 60a(60b). As depicted in FIGS. 1, 2 and 4, the through hole 68 is a hole that perforates the main rubber elastic body 16 in the axial direction and extends for a prescribed length in the circumferential direction diametrically between the inner shaft member 12 and the second pocket portion 36a(36b). The through hole 68 is formed on each side of the inner shaft member 12 in the second diametric direction, so that both of the walls of the pair of the second fluid chambers 60a, 60b have the through hole 68.

With this through hole 68 formed, in the main rubber elastic body 16, the section which constitutes the inside peripheral wall of the second fluid chamber 60a(60b) is made thin so as to define a first flexible film 70. The first flexible film 70 is a thin-walled rubber film which is readily deformable, and is integrally formed with the main rubber elastic body 16. As described above, a part of the wall of the second fluid chamber 60a(60b) is defined by the first flexible film 70, so that the second fluid chamber 60a(60b) readily permits changes in volume owing to deformation of the first flexible film 70. Meanwhile, with respect to the first fluid chamber 58a(58b), a part of the wall thereof is defined by the main rubber elastic body 16, so that during input of vibration, internal pressure fluctuations will be induced owing to deformation of the main rubber elastic body 16.

Furthermore, a recess 72 is formed in the axial end portion of the main rubber elastic body 16. The recess 72 opens onto each axial end face of the main rubber elastic body 16, and as depicted in FIGS. 1 and 4, the recess 72 is formed on each side of the inner shaft member 12 in the second diametric direction. Specifically, the main rubber elastic body 16 has four recesses 72; two of the recesses 72 are provided on axially opposite sides of the second fluid chamber 60a while the other two recesses 72 are provided on axially opposite sides of the second fluid chamber 60b. With this arrangement, the axially opposite walls of the second fluid chamber 60a(60b) define second flexible films 74 provided by the thin-walled rubber elastic body.

Moreover, as depicted in FIG. 1, the through hole 68 penetrates the inside peripheral end of the recess 72. Accordingly, as depicted in FIG. 4, the first flexible film 70 and the second flexible films 74 are formed in continuous fashion. Specifically, in the main rubber elastic body 16, a hollow portion 76 is defined by the through hole 68 and the recesses 72, and the first and second flexible films 70, 74 configured by the hollow portion 76 define a flexible film 78 that constitutes a part of the wall of the second fluid chamber 60a(60b).

The suspension bushing 10 constructed in the above manner is mounted onto a vehicle with the inner shaft member 12 secured by bolts to a vehicle body (not shown) while the outer cylindrical member 14 secured press-fit into an installation hole of a suspension arm (not shown). By so doing, the suspension arm is linked to the vehicle body in a vibration damped manner via the suspension bushing 10. It should be noted that the suspension bushing 10 is installed so that the first diametric direction coincides with the principal vibration input direction.

When a low-frequency vibration is input in the first diametric direction (the vertical direction in FIG. 2), the inner shaft member 12 and the outer cylindrical member 14 experience relative displacement in the first diametric direction. Consequently, relative fluid pressure fluctuation will be produced between the pair of the first fluid chambers 58a, 58b owing to elastic deformation of the main rubber elastic body 16. Accordingly, fluid flow will be produced through the first orifice passage 62 that interconnects the first fluid chamber 58a and the first fluid chamber 58b, thereby obtaining vibration damping effect on the basis of flow behavior of the fluid.

On the other hand, when a vibration of frequency higher than the tuning frequency of the first orifice passage 62 is input in the same first diametric direction, the fluid pressure of the first fluid chamber 58b will be fluctuated relative to the fluid pressure of the second fluid chambers 60a, 60b owing to elastic deformation of the main rubber elastic body 16. Accordingly, fluid flow will be produced through the second orifice passage 64 that interconnects the first fluid chamber 58b and the second fluid chamber 60a as well as through the third orifice passage 66 that interconnects the first fluid chamber 58b and the second fluid chamber 60b, thereby obtaining vibration damping effect on the basis of flow behavior of the fluid.

The vibration damping effect on the basis of the flow behavior of the fluid as described above will efficiently be exhibited by the fluid flow smoothly produced through the orifice passages 62, 64, and 66. Note that in the suspension bushing 10, the flexible films 78 are arranged in a part of the pair of the second fluid chambers 60a, 60b, so that enhanced vibration damping effect will be attained particularly with respect to the high-frequency vibration.

Specifically, if the entire wall of the second fluid chambers 60a, 60b is constituted by the main rubber elastic body 16, changes in volume would be small during vibration input in the first diametric direction (the vertical direction in FIG. 2). Consequently, fluid inflow to the second fluid chambers 60a, 60b from the first fluid chamber 58b as well as fluid outflow from the second fluid chambers 60a, 60b to the first fluid chamber 58b are less likely to be produced, resulting in a tendency to limit the amount of fluid flow through the second and third orifice passages 64, 66. To meet this end, in the suspension bushing 10, a part of the wall of the second fluid chambers 60a, 60b is defined by the thin-walled flexible film 78, thereby readily permitting changes in volume of the second fluid chambers 60a, 60b. Accordingly, when vibration input induces pressure fluctuations within the first fluid chamber 58b, fluid inflow to the second fluid chambers 60a, 60b from the first fluid chamber 58b as well as fluid outflow from the second fluid chambers 60a, 60b to the first fluid chamber 58b will efficiently take place. By so doing, it is possible to obtain a sufficient amount of fluid flow through the second and third orifice passages 64, 66, so that vibration damping effect on the basis of flow behavior of the fluid will be advantageously achieved.

Moreover, in the suspension bushing 10, the first flexible film 70, which is configured in the inside peripheral wall of the second fluid chamber 60a(60b) by the through hole 68, and the pair of the second flexible films 74, 74, which are configured in the axially opposite walls of the second fluid chamber 60a(60b) by the recesses 72, are provided in continuous fashion. Thus, the flexible film 78 of large surface area is formed in the wall of the second fluid chamber 60a(60b) with exceptional space efficiency. With this arrangement, the second fluid chambers 60a, 60b enjoy a sufficiently high level of allowable change in volume, so that desired vibration damping effect will be exhibited more advantageously owing to the effective fluid flow through the second and third orifice passages 64, 66.

Besides, in the suspension bushing 10, each of the partition walls 38a, 38b, 38c, and 38d, which extends from the axially medial portion of the main rubber elastic body 16 between the inner shaft member 12 and the intermediate sleeve 24, extends in the direction away from the principal vibration input direction. With this arrangement, during input of vibration in the principal vibration input direction, shear deformation predominates and the spring rigidity is low in each of the partition walls 38a through 38d. Accordingly, the inner shaft member 12 and the outer cylindrical member 14 will efficiently experience relative displacement, thereby effectively inducing internal pressure fluctuations within the pair of the first fluid chambers 58a, 58b. As a result, it is possible to obtain an advantageous amount of fluid flow through the orifice passages 62, 64, and 66, so that vibration damping effect on the basis of flow behavior of the fluid will be effectively achieved.

Furthermore, there is disposed the stopper portion 22 that projects from the inner shaft member 12 to the outer cylindrical member 14 so as to project into the pair of the first fluid chambers 58a, 58b. The stopper mechanism is provided thereby for limiting relative displacement of the inner shaft member 12 and the outer cylindrical member 14 in the principal vibration input direction. With this arrangement, when excessive load is input, the stopper mechanism will limit deformation of the main rubber elastic body 16. As a result, it is possible to employ the main rubber elastic body 16 of configuration such that shear spring predominates in the principal vibration input direction, while achieving sufficient durability.

Moreover, the main rubber elastic body 16 is provided not only between the inner shaft member 12 and the intermediate sleeve 24 but also between the stopper portion 22 and the intermediate sleeve 24. With this arrangement, the main rubber elastic body 16 ensures a large portion for being compressed in the second diametric direction. Therefore, it is possible to set a large differential between the spring rigidity in the first diametric direction and the spring rigidity in the second diametric direction, thereby attaining a greater degree of freedom in tuning of spring ratio therebetween.

Additionally, owing to the stopper portion 22, the compression spring component in the second diametric direction is set great. Thus, reduction of the spring rigidity associated with forming the hollow portion 76 can be minimized. Accordingly, in the main rubber elastic body 16, it is possible to establish a large ratio of the spring constant in the second diametric direction with respect to the spring constant in the first diametric direction, so that the spring ratio can be set according to the required spring characteristics.

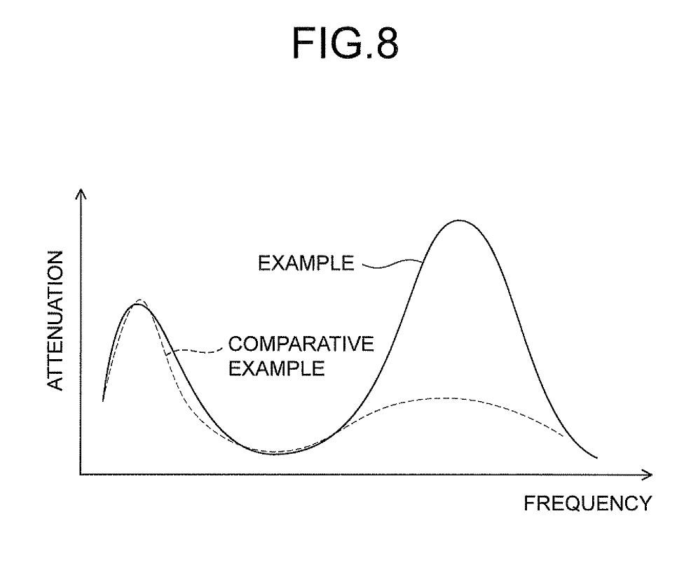

From the test results shown in FIG. 8, it is possible to confirm that the suspension bushing 10 constructed according to the present embodiment (Example) is able to exhibit excellent vibration damping effects against two types of vibration having different frequencies. Specifically, during input of low-frequency vibration, as indicated by the solid line in FIG. 8, vibration damping effect (attenuating action) is effectively exhibited by the first orifice passage 62 of the suspension bushing 10, which is substantially identical to that of the suspension bushing disclosed in U.S. Pat. No. 7,866,639 (Comparative Example), as indicated by the dashed line in FIG. 8. On the other hand, during input of vibration of higher frequency, the suspension bushing 10 is able to attain vibration damping effect (attenuating action) by the second and third orifice passages 64, 66 which is exceedingly superior to that of the suspension bushing disclosed in U.S. Pat. No. 7,866,639. As will be apparent from the above test results, in the suspension bushing 10 according to the present embodiment (Example), the fluid flow through each of the orifice passages 62, 64, and 66 will efficiently take place, making it possible to exhibit vibration damping effect on the basis of flow behavior of the fluid more effectively in comparison with the suspension bushing of conventional construction (Comparative Example).

While the present invention has been described in detail hereinabove in terms of the preferred embodiment, the invention is not limited by the specific disclosures thereof. For example, the specific shape of the hollow portion 76 is not limited in any particular way. Specifically, the hollow portion 76 may be formed, for example, only by the through hole 68, or alternatively, only by the recess 72. Moreover, the shape of the through hole 68 or the recess 72 can be changed appropriately depending on the required spring characteristics or the level of allowable change in volume of the second fluid chambers 60a, 60b. It is also possible to provide the hollow portion 76 in a part of the partition walls 38a through 38d so as to form the flexible film 78.

In addition, the stopper portion 22 may project peripherally inward from the first and second orifice members 40, 42, and is not necessarily limited to that fixed to the inner shaft member 12.

Furthermore, whereas in the preceding embodiment, the first through third orifice passages 62, 64, and 66 are illustrated as the orifice passage, the number or shape of the orifice passage would appropriately be determined depending on the desired vibration damping characteristics or the like. As a specific example, it is acceptable to form an orifice passage that interconnects the first fluid chamber 58a and the second fluid chamber 60a, and an orifice passage that interconnects the first fluid chamber 58b and the second fluid chamber 60b. These orifice passages may be tuned to mutually different frequencies, or alternatively to the same frequency. It is to be understood that four or more orifice passages may be provided.

Besides, the present invention is not limited to application in a suspension bushing, and may be implemented advantageously in fluid-filled cylindrical vibration-damping devices for any of various other applications. Moreover, the present invention is not limited to automotive fluid-filled cylindrical vibration-damping devices only, and is adaptable to implementation in motorized two wheeled vehicles, rolling stock, commercial automobiles, or the like.

What is claimed is:

1. A fluid-filled cylindrical vibration-damping device comprising:
an inner shaft member;
an outer cylindrical member externally fitted about the inner shaft member;
a main rubber elastic body elastically connecting the inner shaft member and the outer cylindrical member;
a plurality of pocket portions provided in the main rubber elastic body so as to open onto an outer peripheral face of the main rubber elastic body;
a plurality of fluid chambers defined by covering an opening of the pocket portions with the outer cylindrical member each filled with a non-compressible fluid, the plurality of fluid chambers comprising a pair of first fluid chambers opposed to each other in a first diametric direction with the inner shaft member being interposed therebetween and a pair of second fluid chambers opposed to each other in a second diametric direction orthogonal to the first diametric direction;
an orifice passage connecting the first fluid chambers and the second fluid chambers; and
partition walls that circumferentially partition the first fluid chambers and the second fluid chambers respectively, each of the partition walls extending between the inner shaft member and the outer cylindrical member in a direction in more proximity to the second diametric direction in which the pair of the second fluid chambers are opposed to each other than to the first diametric direction in which the pair of the first fluid chambers are opposed to each other,
wherein the main rubber elastic body is provided with a hollow portion at a section which constitutes a wall of the second fluid chamber so that at least a part of the wall of the second fluid chamber is defined by a thin-walled flexible film.

2. The fluid-filled cylindrical vibration-damping device according to claim 1, wherein the hollow portion extends in a circumferential direction between the inner shaft member and the outer cylindrical member so that the flexible film is provided in the wall situated on an inner peripheral side of the second fluid chamber.

3. The fluid-filled cylindrical vibration-damping device according to claim 1, wherein the hollow portion includes a recess that opens onto an axial end face of the main rubber elastic body.

4. The fluid-filled cylindrical vibration-damping device according to claim 1, further comprising a stopper portion that projects into the pair of the first fluid chambers in the first diametric direction between the inner shaft member and the outer cylindrical member for limiting an amount of relative displacement of the inner shaft member and the outer cylindrical member in the first diametric direction by means of abutment of the inner shaft member and the outer cylindrical member via the stopper portion.

5. The fluid-filled cylindrical vibration-damping device according to claim 4, wherein the stopper portion projects in the first diametric direction from the inner shaft member towards the outer cylindrical member, and
the main rubber elastic body is provided between a surface defined by the inner shaft member and the stopper portion and a surface of the outer cylindrical member opposed in the second diametric direction.

6. The fluid-filled cylindrical vibration-damping device according to claim 1, wherein the pair of the first fluid chambers are formed so as to be opposed to each other in the first diametric direction which coincides with a principal vibration input direction.
